(19) United States
(12) Patent Application Publication
(10) Pub. No.: US 2025/0363000 A1
(43) Pub. Date: Nov. 27, 2025

(54) MEMORY CONTROLLER AND OPERATING METHOD THEREOF

(71) Applicant: SK hynix Inc., Icheon-si (KR)

(72) Inventors: Myung Jin JO, Icheon-si (KR); Wan Je SUNG, Icheon-si (KR); Hee Sang LEE, Icheon-si (KR)

(21) Appl. No.: 19/044,436

(22) Filed: Feb. 3, 2025

(30) Foreign Application Priority Data
May 27, 2024 (KR) 10-2024-0068451

(51) Int. Cl. G06F 11/10

(52) U.S. Cl. CPC G06F 11/1044

(57) ABSTRACT

A memory controller for efficiently managing power may include a memory interface, a power manager, and an Error Correction Code (ECC) engine. The memory interface may perform a data input/output operation of transmitting/receiving data to/from a memory device through an input/output line. The power manager may monitor a peak current period of the data input/output operation, and generate peak sensing information when the peak current period is sensed. The ECC engine may perform an error correction operation on the data while the data input/output operation is performed, and control a speed of the error correction operation in the peak current period in response to the peak sensing information.

### CROSS-REFERENCE TO RELATED APPLICATION

The present application claims priority under 35 U.S.C. § 119 (a) to Korean patent application number 10-2024-0068451 filed on May 27, 2024, in the Korean Intellectual Property Office, the entire disclosure of which is incorporated by reference herein.

### BACKGROUND

### 1. Technical Field

The present disclosure generally relates to an electronic device, and more particularly, to a memory controller and an operating method thereof.

### 2. Related Art

A storage device is a device that stores data under the control of a host device such as a computer or a smartphone. The storage device may include a memory device that stores data and a memory controller that controls the memory device. The memory device can be classified into volatile memory devices and nonvolatile memory devices.

Volatile memory devices are memory devices in which data is stored only when power is supplied, but stored data becomes inaccessible when the supply of power is interrupted. Examples of volatile memory devices may include a Static Random Access Memory (SRAM), a Dynamic Random Access Memory (DRAM), and the like.

Nonvolatile memory devices are memory devices in which data retained and accessible even when the supply of power is interrupted. Examples of nonvolatile memory devices may include Read Only Memory (ROM), Programmable ROM (PROM), an Electrically Programmable ROM (EPROM), Electrically Erasable ROM (EEROM), flash memory, and the like.

### SUMMARY

Embodiments provide a memory controller for efficiently managing power and method of operating the memory controller.

In accordance with an aspect of the present disclosure, there is provided a memory controller including: a memory interface configured to perform a data input/output operation of transmitting/receiving data to/from a memory device through an input/output line; a power manager configured to monitor a peak current period of the data input/output operation, and generate peak sensing information when the peak current period is sensed; and an Error Correction Code (ECC) engine configured to perform an error correction operation on the data while the data input/output operation is performed, and control a speed of the error correction operation in the peak current period in response to the peak sensing information.

In accordance with another aspect of the present disclosure, there is provided a method of operating a memory controller, the method including: performing a data input/output operation of transmitting/receiving data to/from a memory device through an input/output line; performing an error correction operation on the data while the data input/output operation is performed; monitoring a peak current period of the data input/output operation, and generating peak sensing information when the peak current period is sensed; and controlling a speed of the error correction operation in the peak current period in response to the peak sensing information.

### BRIEF DESCRIPTION OF THE DRAWINGS

Example embodiments will now be described more fully hereinafter with reference to the accompanying drawings; however, the inventions may be embodied in different forms and should not be construed as limited to the embodiments set forth herein. Rather, these embodiments are provided so that this disclosure will be thorough and complete, and will fully convey the scope of the example embodiments to those skilled in the art.

In the drawings, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a diagram illustrating a storage device in accordance with embodiments of the present disclosure.

FIG. 2 is a diagram illustrating a memory device shown in FIG. 1 in accordance with embodiments of the present disclosure.

FIG. 3 is a diagram illustrating a configuration and an operation of a memory controller in accordance with an embodiment of the present disclosure.

FIG. 4 is a diagram illustrating a consumed current in a data input/output operation and an error correction operation.

FIG. 5 is a diagram illustrating a consumed current in a data input/output operation and an error correction operation in accordance with an embodiment of the present disclosure.

FIG. 6 is a diagram illustrating a consumed current in a data input/output operation and an error correction operation in accordance with an embodiment of the present disclosure.

FIG. 7 is a diagram illustrating an optional error correction operation applied according to an error level in accordance with an embodiment of the present disclosure.

FIG. 8 is a flowchart illustrating an operation of a memory controller in accordance with an embodiment of the present disclosure.

FIG. 9 is a flowchart illustrating an operation of a memory controller in accordance with an embodiment of the present disclosure.

FIG. 10 is a flowchart illustrating an operation of a memory controller in accordance with an embodiment of the present disclosure.

FIG. 11 is a diagram illustrating another embodiment of a memory controller shown in FIG. 1 in accordance with embodiments of the present disclosure.

### DETAILED DESCRIPTION

The specific structural or functional description disclosed herein is merely illustrative for the purpose of describing embodiments according to the concepts of the present disclosure. The embodiments according to the concepts of the present disclosure can be implemented in various forms, and cannot be construed as limited to the embodiments set forth herein.

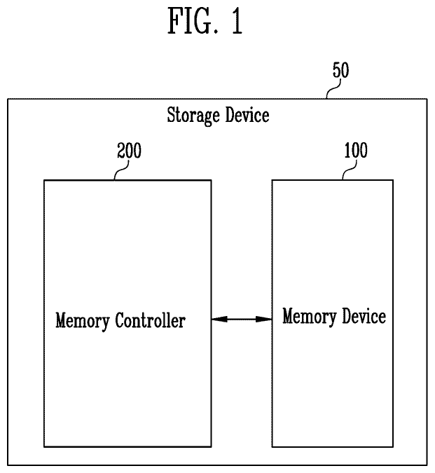

FIG. 1 is a diagram illustrating a storage device in accordance with embodiments of the present disclosure.

Referring to FIG. 1, a storage device 50 may include a memory device 100 and a memory controller 200. The storage device 50 may be a device which stores data under the control of a host, such as a mobile phone, a smartphone, a laptop computer, a server computer, a desktop computer, a game console, a TV, a tablet PC or an in-vehicle infotainment system. In an embodiment, the storage device 50 may be a device controlled by a host through wired/wireless communication, which stores data in a remote place, such as a server or a data center.

The storage device 50 may interface with the host in various communication schemes, and be configured as any one of various devices according to an interfacing scheme. For example, the storage device 50 may be configured as any one of a variety of types of storage devices, such as a Solid State Drive (SSD), an embedded Multi-Media Card (eMMC), a secure digital card in the form of an SD, a mini-SD or a micro-SD, a Universal Serial Bus (USB) storage device, a Universal Flash Storage (UFS) device, a Personal Computer Memory Card International Association (PCMCIA) card type storage device, a Peripheral Component Interconnection (PCI) card type storage device, a PCI Express (PCI-E) card type storage device, a Compact Flash (CF) card, and a smart media card.

In embodiments, the storage device 50 may be manufactured as any one of various kinds of package types. For example, the storage device 50 may be manufactured as any one of various kinds of package types such as a Package-On-Package (POP), a System-In-Package (SIP), a System-On-Chip (SOC), a Multi-Chip Package (MCP), a Chip-On-Board (COB), a Wafer-level Fabricated Package (WFP), and a Wafer-level Stack Package (WSP).

The memory device 100 may store data. The memory device 100 may operate under the control of the memory controller 200. The memory device 100 may include a plurality of memory cells that store data. Each of the memory cells may be configured to store one data bit or a plurality of data bits.

The memory cells may be accessed in a predetermined size unit according to the kind of a memory device. A unit in which the memory cells are accessed may vary for each operation. For example, the memory cells may be accessed in different size units in a write operation (program operation) of storing data in a memory cell, a read operation of sensing data stored in a memory cell, and an erase operation of erasing data stored in a memory cell.

In an embodiment, the memory device 100 may be a Double Data Rate Synchronous Dynamic Random Access Memory (DDR SDRAM), a Low Power Double Data Rate 4 (LPDDR4) SDRAM, a Graphics Double Data Rate (GDDR) SRAM, a Low Power DDR (LPDDR), a Rambus Dynamic Random Access Memory (RDRAM), a NAND flash memory, a vertical NAND flash memory, a NOR flash memory, a Resistive Random Access Memory (RRAM), a Phase-Change Random Access Memory (PRAM), a Magnetoresistive Random Access Memory (MRAM), a Ferroelectric Random Access Memory (FRAM), or a Spin Transfer Torque Random Access Memory (STT-RAM).

The memory device 100 may receive a command and an address from the memory controller 200, and access an area selected by the address in the memory cell array. The memory device 100 may perform an operation indicated by the command on the area selected by the address. For example, the memory device 100 may perform a write operation (program operation), a read operation, and an erase operation. In the program operation, the memory device 100 may record data in the area selected by the address. In the read operation, the memory device 100 may sense data from the area selected by the address. In the erase operation, the memory device 100 may erase data stored in the area selected by the address.

The memory controller 200 may control overall operations of the storage device 50.

When power is applied to the storage device 50, the memory controller 200 may execute firmware (FW). The storage device 50 may translate a Logical Block Address (LBA), which the host provides, into a Physical Block Address (PBA), which the memory device 100 uses. The LBA may be an address for identifying data that the host provides. The PBA may be an address indicating a position at which data is stored in the memory device 100. In this specification, the LBA may have the same meaning as a logical address, and the PBA may have the same meaning as a physical address.

The memory controller 200 may control the memory device 100 to perform a write operation, a read operation, an erase operation, or the like according to a request of the host. In the write operation, the memory controller 200 may provide the memory device 100 with a write command (program command), an address, and data. In the read operation, the memory controller 200 may provide the memory device 100 with a read command and an address. In the erase operation, the memory controller 200 may provide the memory device 100 with an erase command and an address.

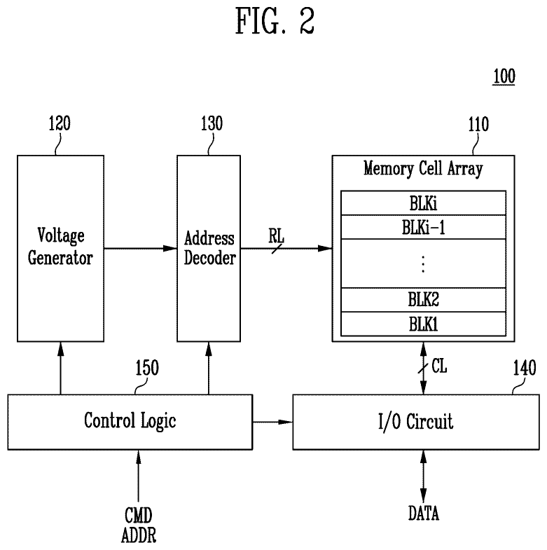

FIG. 2 is a diagram illustrating a memory device shown in FIG. 1 in accordance with embodiments of the present disclosure.

Referring to FIG. 2, a memory device 100 may include a memory cell array 110, a voltage generator 120, an address decoder 130, an input/output (I/O) circuit 140, and a control logic 150.

The memory cell array 110 may include a plurality of memory blocks BLK1 to BLKi. The plurality of memory blocks BLK1 to BLKi may be connected to the address decoder 130 through row lines RL. The plurality of memory blocks BLK1 to BLKi may be connected to the I/O circuit 140 through column lines CL. In an embodiment, the row lines RL may include word lines, source select lines, and drain select lines. In an embodiment, the column lines may include bit lines.

Each of the plurality of memory blocks BLK1 to BLKi includes a plurality of memory cells. In an embodiment, the plurality of memory cells may be nonvolatile memory cells. Among the plurality of memory cells, memory cells connected to the same word line may be defined as one page. That is, each of the plurality of memory blocks BLK1 to BLKi may include a plurality of pages.

Each of the memory cells included in the memory cell array 110 may be configured as a Single Level Cell (SLC) storing one data bit, a Multi-Level Cell (MLC) storing two data bits, a Triple Level Cell (TLC) storing three data bits, or a Quadruple Level Cell (QLC) storing four data bits.

In an embodiment, the voltage generator 120, the address decoder 130, and the I/O circuit 140 may be commonly designated as a peripheral circuit. The peripheral circuit may drive the memory cell array 110 under the control of the control logic 150. The peripheral circuit may driver the memory cell array 110 to perform a write operation (program operation), a read operation, and an erase operation.

The voltage generator 120 may generate a plurality of operating voltages by using an external power voltage supplied to the memory device 100. The voltage generator 120 may be operated under the control of the control logic 150. In an embodiment, the voltage generator 120 may generate an internal power voltage by regulating the external power voltage. The internal power voltage generated by the voltage generator 120 may be used as an operating voltage of the memory device 100.

In an embodiment, the voltage generator 120 may generate a plurality of operating voltages by using the external power voltage or the internal power voltage. The voltage generator 120 may generate various voltages required in the memory device 100. For example, the voltage generator 120 may generate a plurality of erase voltages, a plurality of program voltages, a plurality of pass voltages, a plurality of select read voltages, and a plurality of unselect read voltages.

In order to generate a plurality of operating voltages having various voltage levels, the voltage generator 120 may include a plurality of pumping capacitors that receive internal power voltage. The voltage generator 120 may generate a plurality of operating voltages by selectively enabling the plurality of pumping capacitors under the control of the control logic 150.

The plurality of generated operating voltages may be supplied to the memory cell array 110 by the address decoder 130.

The address decoder 130 may be connected to the memory cell array 110 through the row lines RL. The address decoder 130 may be operated under the control of the control logic 150. The address decoder 130 may receive an address ADDR from the control logic 150. The address decoder 130 may decode a block address in the received address ADDR. The address decoder 130 may select at least one memory block among the plurality of memory blocks BLK1 to BLKi according to the decoded block address. The address decoder 130 may decode a row address in the received address ADDR. The address decoder 130 may select at least one word line among word lines of the selected memory block according to the decoded row address. In an embodiment, the address decoder 130 may decode a column address in the received address ADDR. The I/O circuit 140 and the memory cell array 110 may be connected to each other according to the decoded column address.

In an example, the address decoder 130 may include components such as a row decoder, a column decoder, and an address decoder.

The I/O circuit 140 may include a plurality of page buffers (not shown). The plurality of page buffers may be connected to the memory cell array 110 through bit lines. In a write operation (program operation), data may be stored in selected memory cells according to data stored in the plurality of page buffers. In a read operation, the data stored in the selected memory cells may be sensed through the bit lines, and the sensed data may be stored in the page buffers.

The control logic 150 may control the address decoder 130, the voltage generator 120, and the I/O circuit 140. The control logic 150 may be operated in response to a command CMD transferred from an external device. The control logic 150 may control the peripheral circuit by generating control signals in response to the command CMD and the address ADDR.

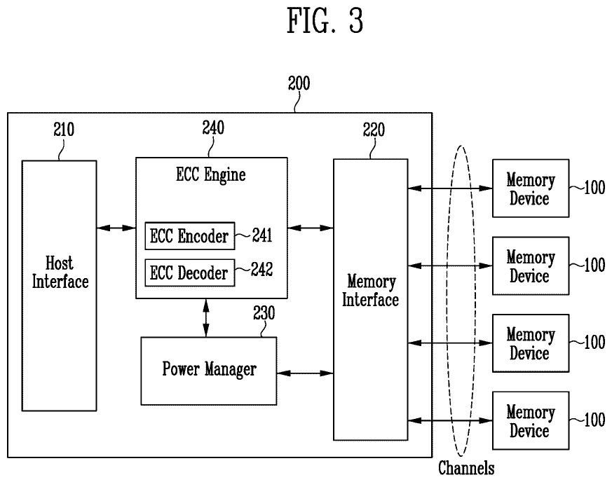

FIG. 3 is a diagram illustrating a configuration and an operation of a memory controller in accordance with an embodiment of the present disclosure.

Referring to FIG. 3, a memory controller 200 may include a host interface 210, a memory interface 220, a power manager 230, and an Error Correction Code (ECC) engine 240. In an embodiment, the ECC engine 240 may be included as a chip or device separate from the memory controller 200 in a storage device 50.

The host interface 210 may receive an access request for a memory device 100 and an address from the host, and transmit/receive data. For example, the host interface 210 may receive an address at which program data is to be stored and the program data together with a write request of the host. The host interface 210 may receive an address at which data is to be read together with a read request of the host. The host interface 210 may transmit data read from memory device 100 to the host.

The memory interface 220 may perform a data input/output operation of transmitting/receiving data to/from the memory device 100 through an input/output line. The memory interface 220 may transmit program data to the memory device 100 or receive read data from the memory device 100.

The memory interface 220 may transmit/receive data to/from a plurality of memory devices 100. The current consumed by the data input/output operations may be increased as the number of memory devices 100 simultaneously performing transmission/reception increases.

The power manager 230 may monitor current consumed by a data input/output operation through a status check of the input/output line. The power manager 230 may monitor a peak current period of the data input/output operations, and generate peak sensing information when the peak current period is sensed.

The ECC engine 240 may include an ECC encoder 241 and an ECC decoder 242. The ECC encoder 241 may perform error correction encoding on program data transmitted to the memory device 100. The ECC decoder may perform error correction decoding on read data received from the memory device 100. The ECC decoder 242 may perform the error correction decoding, using various algorithms employing an iterative decoding scheme. For example, the algorithms may include a bit flipping algorithm, a sum-product algorithm, a min-sum algorithm, a scaled min-sum algorithm, and the like. The kinds of algorithms are not limited to embodiments of the present disclosure. Errors included in the read data may be detected and corrected through the error correction decoding.

The ECC engine 240 may perform an error correction operation on data while a data input/output operation is performed. The ECC engine 240 may control a speed of the error correction operation in a peak current period in response to peak sensing information received from the power manager 230. An error correction operation may be error correction encoding or error correction decoding.

The ECC engine 240 may decrease the speed of an error correction operation in a peak current period, and increase the speed of an error correction operation after the peak current period. For example, the ECC engine 240 may make the error correction speed lower than a default speed in a peak current period, and make the speed of the error correction operation faster than the default speed after a peak current period.

The ECC engine 240 may decrease the frequency of error correction operations in a peak current period, and increase the frequency of error corrections operation after a peak current period. The ECC engine 240 may make the frequency of error correction operations lower than a default frequency or make the frequency of the error correction operations higher than the default frequency.

In an embodiment, the ECC engine 240 may check an error level of data, and control the speed of an error correction operation in a peak current period according to the error level.

When the error level is a reference value or less, the ECC engine 240 may set the speed of the error correction operation as the default speed in the peak current period. When the error level is higher than the reference value, the ECC engine 240 may set the speed of the error correction operation to be lower than the default speed in the peak current period.

When the error level is a reference value or less, the ECC engine 240 may set the frequency of the error correction operation as the default frequency. When the error level is higher than the reference value, the ECC engine 240 may set the frequency of the error correction operation to be lower than the default frequency.

In an embodiment, the ECC engine 240 may perform the error correction operation after the peak current period. For example, when the error level is higher than the reference value, the ECC engine 240 may perform the error correction operation after the peak current period.

In an embodiment, the memory interface 220 may perform the data input/output operation, using a plurality of memory devices 100 and a plurality of channels. When a plurality ECC engines 240 are provided, at least one channel from among the plurality of channels may share any one ECC engine from among the plurality of ECC engines (not shown).

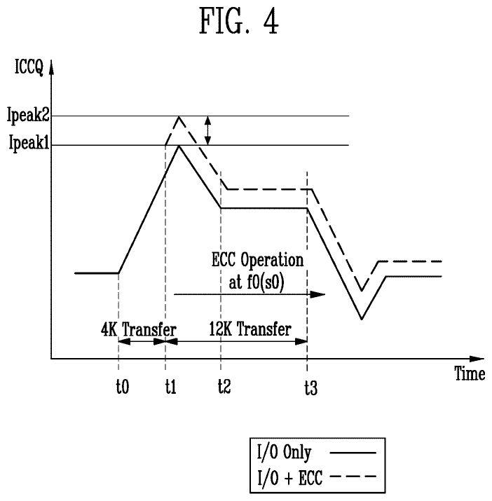

FIG. 4 is a diagram illustrating a consumed current in a data input/output operation and an error correction operation.

Referring to FIG. 4, in a period from time t0 to t3, a memory interface may perform a data input/output operation. A period from time t1 to t2 may be a peak current period for the data input/output operation. In a period from time t1 to t3, the ECC engine may perform an error correction operation on read data. A frequency of the error correction operation may be f0, and a speed of the error correction operation may be s0. Frequency f0 may be a default frequency, and speed s0 may be a default speed.

ICCQ represents a consumed current in a data input/output operation. When only a data input/output operation is performed, a magnitude of a peak current in the peak current period may be Ipeak1. When a data input/output operation and an error correction operation are performed together, a magnitude of the peak current in the peak current period may be Ipeak2. That is, the magnitude of the peak current may increase as the error correction operation is performed. As the magnitude of the peak current becomes larger, a voltage drop may become larger, and a malfunction probability of the data input/output operation and the error correction operation may become higher.

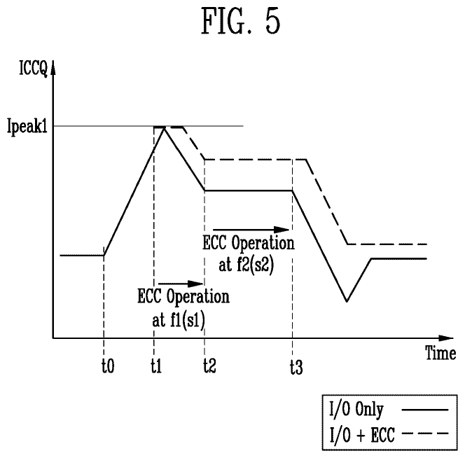

Therefore, an embodiment for decreasing the magnitude of the peak current in the peak current period will be described with reference to FIGS. 5 to 7.

FIG. 5 is a diagram illustrating a consumed current in a data input/output operation and an error correction operation in accordance with an embodiment of the present disclosure.

Referring to FIG. 5, in a period from time t0 to t3, a memory interface may perform a data input/output operation. A period from time t1 to t2 may be a peak current period of the data input/output operation. In a period from time t1 to t3, an ECC engine may perform an error correction operation on read data. The ECC engine may control the speed of the error correction operation in the peak current period.

For example, in a period from time t1 to t2, the ECC engine may decrease the frequency and speed of the error correction operation. In a period from time t2 to t3, the ECC engine may increase the frequency and speed of the error correction operation. In a period from time t1 to t2, the ECC engine may decrease the frequency of the error correction operation to frequency f1, which is lower than a frequency f0 (not illustrated), as the default frequency, and decrease the speed of the error correction operation to speed s1, which is lower than speed s0 (not illustrated), as the default speed. In a period from time t2 to t3, the ECC engine may increase the frequency of the error correction operation to frequency f2, which is higher than frequency f0 as the default frequency, and increase the speed of the error correction operation to speed s2, which is faster than speed s0 as the default speed.

In accordance with an embodiment described with reference to FIG. 5, the speed and frequency of the error correction operations are decreased in the peak current period of the data input/output operation, so that an increase in the peak current can be prevented. In addition, the speed and frequency of the error correction operation are increased after the peak current period, so that performance of the error correction operation can be maintained.

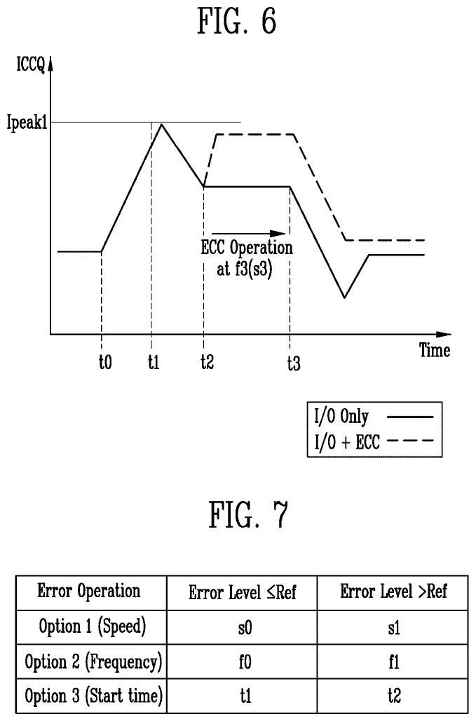

FIG. 6 is a diagram illustrating a consumed current in a data input/output operation and an error correction operation in accordance with an embodiment of the present disclosure.

Referring to FIG. 6, in a period of time t0 to t3, a memory interface may perform a data input/output operation. A period of time t1 to t2 may be a peak current period of the data input/output operation. In a period of time t1 to t3, an ECC engine may perform an error correction operation on read data. The frequency of the error correction operation may be frequency f3, and the speed of the error correction operation may be speed s3. Frequency f3 may be higher than frequency f0 (not illustrated) as the default frequency, and speed s3 may be higher than speed s0 (not illustrated) as the default speed.

That is, the ECC engine performs the error correction operation after the peak current period, so that an increase in the peak current in the peak current period of the data input/output operation can be prevented or skipped. In addition, the speed and frequency of the error correction operations are increased after the peak current period, so that the performance of the error correction operation can be maintained.

FIG. 7 is a diagram illustrating an optional error correction operation applied according to an error level in accordance with an embodiment of the present disclosure.

Referring to FIGS. 4 and 7, an ECC engine may check an error level, based on a number of error bits included in read data received from a memory device. The ECC engine may perform an error correction operation according to various options, based on a result obtained by comparing the checked error level with a reference value Ref.

In an embodiment, the ECC engine may set the speed of the error correction operation to speed s0 as the default speed when the error level is the reference value Ref or less, and set the speed of the error correction operation to speed s1, which is slower than speed s0, as the default speed when the error level is higher than the reference value Ref.

In an embodiment, the ECC engine may set the frequency of the error correction operation to frequency f0 as the default frequency when the error level is the reference value Ref or less, and set the frequency of the error correction operation to frequency f1, which is lower than frequency f0, as the default frequency when the error level is higher than the reference value Ref.

In an embodiment, the ECC engine may perform the error correction operation at a time t1 at which the peak current period begins when the error level is at the reference value Ref or less, and perform the error correction operation at time t2 after the peak current period when the error level is greater than the reference value Vref.

In accordance with an embodiment described with reference to FIG. 7, the performance (speed, frequency, start period, and the like) of an error correction operation is not unconditionally decreased in a peak current period, but selectively controlled according to data error level, so that unnecessary deterioration of the error correction operation can be prevented.

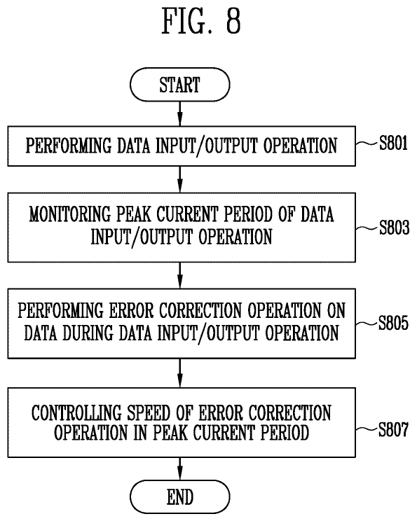

FIG. 8 is a flowchart illustrating an operation of a memory controller in accordance with an embodiment of the present disclosure.

Referring to FIG. 8, in step S801, a memory controller may perform a data input/output operation of transmitting/receiving data to/from a memory device.

In step S803, the memory controller may monitor a peak current period of the data input/output operation.

In step S805, the memory controller may perform an error correction operation on data during the data input/output operation. The error correction operation may be error correction decoding on read data. In another embodiment, the error correction operation may be error correction encoding on program data.

In step S807, the memory controller may control a speed of the error correction operation in the peak current period.

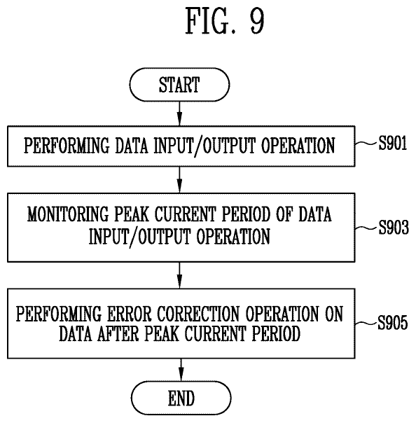

FIG. 9 is a flowchart illustrating an operation of a memory controller in accordance with an embodiment of the present disclosure.

Referring to FIG. 9, in step S901, a memory controller may perform a data input/output operation of transmitting/receiving data to/from a memory device.

In step S903, the memory controller may monitor a peak current period of the data input/output operation.

In step S905, the memory controller may perform an error correction operation on data after the peak current period.

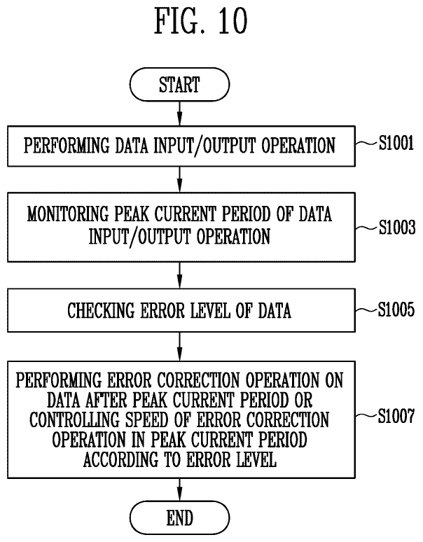

FIG. 10 is a flowchart illustrating an operation of a memory controller in accordance with an embodiment of the present disclosure.

Referring to FIG. 10, in step S1001, a memory controller may perform a data input/output operation of transmitting/receiving data to/from a memory device.

In step S1003, the memory controller may monitor a peak current period of the data input/output operation.

In step S1005, the memory controller may check an error level of data received from the memory device.

In step S1007, the memory controller may perform an error correction operation on data after the peak current period or control a speed of the error correction operation performed during the peak current period, according to the error level and reference values, such as illustrated in FIG. 7.

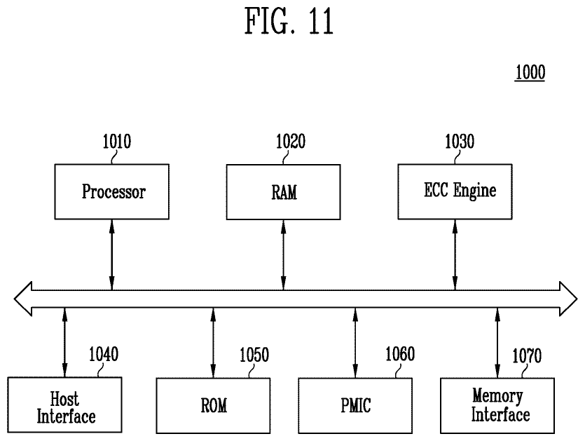

FIG. 11 is a diagram illustrating another embodiment of a memory controller shown in FIG. 1 in accordance with embodiments of the present disclosure.

Referring to FIG. 11, a memory controller 1000 may include a processor 1010, a Random Access Memory (RAM) 1020, an Error Correction Code (ECC) engine 1030, a host interface 1040, a Read Only Memory (ROM) 1050, a Power Management Integrated Circuit (PMIC) 1060, and a memory interface 1070.

The memory controller 1000 may be a memory controller 200 described above with reference to FIG. 3. The ECC engine 1030 may be an ECC engine 240 described above with reference to FIG. 3. The host interface 1040 may be a host interface 210 described above with reference to FIG. 3. The PMIC 1060 may include a power manager 230 described above with reference to FIG. 3. The memory interface 1070 may be a memory interface 220 described above with reference to FIG. 3.

The processor 1010 may control a general operation of the memory controller 1000. The RAM 1020 may be used as a buffer memory, a cache memory, a working memory, or the like.

In an embodiment, the ROM 1050 may store, in a firmware form, various information required when the memory controller 1000 operates.

The memory controller 1000 may communicate with an external device (e.g., a host, an application process, or the like) through the host interface 1040.

The PMIC 1060 may stably maintain a power source supplied to the memory controller 1000 and a memory device 100, and efficiently manage power consumption.

The memory controller 1000 may communicate with the memory device 100 through the memory interface 1070. The memory controller 1000 may transmit a command, an address, a control signal, and the like to the memory device 100 through the memory interface 1070, and transmit/receive data.

In accordance with the present disclosure, there can be provided a memory controller for efficiently managing power and an operating method of the memory controller.

While the present disclosure has been shown and described with reference to certain exemplary embodiments, it will be understood by those skilled in the art that various changes in form and details may be made therein without departing from the spirit and scope of the present disclosure as defined by the appended claims and their equivalents. Therefore, the scope of the present disclosure should not be limited to the above-described exemplary embodiments but should be determined by not only the appended claims but also the equivalents thereof.

In the above-described embodiments, all steps may be selectively performed or part of the steps and may be omitted. In each embodiment, the steps are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

Meanwhile, the exemplary embodiments of the present disclosure have been described in the drawings and specification. Although specific terminologies are used here, those are only to explain the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein.

What is claimed is:

1. A memory controller comprising:
a memory interface configured to perform a data input/output operation of transmitting/receiving data to/from a memory device through an input/output line;
a power manager configured to monitor a peak current period of the data input/output operation, and generate peak sensing information when the peak current period is sensed; and
an Error Correction Code (ECC) engine configured to perform an error correction operation on the data while the data input/output operation is performed, and control a speed of the error correction operation in the peak current period in response to the peak sensing information.

2. The memory controller of claim 1, wherein the ECC engine decreases the speed of the error correction operation in the peak current period, and increases the speed of the error correction operation after the peak current period.

3. The memory controller of claim 2, wherein the ECC engine sets the speed of the error correction operation lower than a default speed in the peak current period, and sets the speed of the error correction operation higher than the default speed after the peak current period.

4. The memory controller of claim 1, wherein the ECC engine decreases a frequency of the error correction operation in the peak current period, and increases the frequency of the error correction operation after the peak current period.

5. The memory controller of claim 4, wherein the ECC engine sets the frequency of the error correction operation lower than a default frequency in the peak current period, and sets the frequency of the error correction operation higher than the default frequency after the peak current period.

6. The memory controller of claim 1, wherein the ECC engine performs the error correction operation after the peak current period.

7. The memory controller of claim 1, wherein the ECC engine checks an error level of the data, and controls the speed of the error correction operation in the peak current period according to the error level.

8. The memory controller of claim 7, wherein, when the error level is a reference value or less, the ECC engine sets the speed of the error correction operation as a default speed in the peak current period.

9. The memory controller of claim 8, wherein, which the error level is higher than the reference value, the ECC engine sets the speed of the error correction operation lower than the default speed in the peak current period.

10. The memory controller of claim 7, wherein, when the error level is a reference value or less, the ECC engine sets a frequency of the error correction operation as a default frequency in the peak current period.

11. The memory controller of claim 10, wherein, when the error level is higher than the reference value, the ECC engine sets the frequency of the error correction operation lower than the default frequency in the peak current period.

12. The memory controller of claim 7, wherein, when the error level is higher a reference value, the ECC engine performs the error correction operation after the peak current period.

13. The memory controller of claim 1, wherein the power manager monitors a consumed current of the data input/output operation through a status check of the input/output line.

14. The memory controller of claim 1, wherein the ECC engine includes:
an ECC encoder configured to perform error correction encoding on a program data transmitted to the memory device; and
an ECC decoder configured to perform error correction decoding on a read data received from the memory device, and
wherein the error correction operation includes the error correction encoding and the error correction decoding.

15. The memory controller of claim 1, wherein the memory interface performs the data input/output operation using a plurality of memory devices and a plurality of channels, and
wherein at least one channel from among the plurality of channels shares any one ECC engine from among a plurality of ECC engines.

16. A method of operating a memory controller, the method comprising:
performing a data input/output operation of transmitting/receiving data to/from a memory device through an input/output line;
performing an error correction operation on the data while the data input/output operation is performed;
monitoring a peak current period of the data input/output operation, and generating peak sensing information when the peak current period is sensed; and
controlling a speed of the error correction operation in the peak current period in response to the peak sensing information.

17. The method of claim 16, wherein the controlling of the speed of the error correction operation includes:
decreasing the speed of the error correction operation in the peak current period; and
increasing the speed of the error correction operation after the peak current period.

18. The method of claim 16, wherein the controlling of the speed of the error correction operation includes:
decreasing a frequency of the error correction operation in the peak current period; and
increasing the frequency of the error correction operation after the peak current period.

19. The method of claim 16, wherein the controlling of the speed of the error correction operation includes:
checking an error level of the data; and
decreasing the speed of the error correction operation in the peak current period when the error level is higher than a reference value.

20. A method of operating a memory controller, the method comprising:
performing a data input/output operation of transmitting/receiving data to/from a memory device through an input/output line;
monitoring a peak current period of the data input/output operation, and generating peak sensing information when the peak current period is sensed; and
performing an error correction operation on the data after the peak current period.

21. The method of claim 20, wherein the performing of the error correction operation includes:
checking an error level of the data; and
performing the error correction operation after the peak current period when the error level is higher than a reference value.
